(19) United States
(12) Patent Application Publication
(10) Pub. No.: US 2026/0111599 A1
(43) Pub. Date: Apr. 23, 2026

(54) Memory-Augmented Fiber Sensing Recognition and Adaptation based on Disaggregated Computing with Double Privacy Protection

(71) Applicant: NEC Laboratories America, Inc., Princeton, NJ (US)

(72) Inventors: Shaobo Han, Princeton, NJ (US); Philip Ji, Cranbury, NJ (US); Ting Wang, West Windsor, NJ (US)

(73) Assignee: NEC Laboratories America, Inc., Princeton, NJ (US)

(21) Appl. No.: 19/364,288

(22) Filed: Oct. 21, 2025

Related U.S. Application Data
(60) Provisional application No. 63/709,547, filed on Oct. 21, 2024.

(51) Int. Cl. G06F 21/62; G01H 9/00

(52) U.S. Cl. CPC G06F 21/6245; G01H 9/004

(57) ABSTRACT

A system and method for Distributed Fiber Optic Sensing (DFOS) recognition and adaptation, which utilizes a memory-augmented neural network (MANN) and a disaggregated computing infrastructure (DCI) to achieve double privacy protection. The system separates the feature extraction encoder on a client-side machine from an external memory bank and similarity-based classification module on a server-side machine. In operation, the client computes an embedding from raw sensing data and transmits only the embedding vector to the server. The server performs classification and, during model fine-tuning, calculates and returns a gradient vector with respect to the embedding. This architecture ensures proprietary training data on the server is never exposed, while client raw sensing data remains private. The system supports continuous model adaptation and robust class-incremental learning.

### CROSS REFERENCE TO RELATED APPLICATIONS

This application claims the benefit of U.S. Provisional Patent Application Ser. No. 63/709,547 filed Oct. 21, 2024, the entire contents of which is incorporated by reference as if set forth at length herein.

### FIELD OF THE INVENTION

This application relates generally to Distributed Fiber Optic Sensing (DFOS) systems and methods. More particularly, it pertains to integrated DFOS - Artificial Intelligence (AI) systems and methods that employ memory-augmented fiber sensing recognition and adaption based on disaggregated computing with double privacy protection.

### BACKGROUND OF THE INVENTION

In recent years, distributed fiber optic sensing (DFOS) technology has been used in more and more applications, such as perimeter security, border protection, oil and gas exploration and production, traffic and road monitoring, environment monitoring, natural disaster warning, etc. By analyzing various types of optical backscattering signals (Rayleigh, Brillouin, and Raman), DFOS systems can detect different physical phenomena such as vibration, strain, and temperature over a long distance of optical fiber with fine spatial resolution. These physical data can then be used to extract meaningful events such as intrusion, seismic activity, traffic movement, oil production, construction, etc. The event identification and classification may be performed using advanced machine learning (ML) technologies such as deep neural networks.

With the growing demand for accurate machine learning models, increasing data size, and more complex deep learning architectures, proposals for dynamically reconfigurable physical layers have emerged to enable high throughput, low latency, and seamless failure recovery. These approaches aim to enhance efficiency and reduce the cost of large-scale AI networks. There are also proposals describing distributed inference and fine-tuning of large language models (LLM) over decentralized systems involving geo-distributed devices connected via the Internet. While these efforts focus on architectures for generic applications or general-purpose algorithms, the rapidly expanding DFOS application space necessitates urgent consideration of computing and networking infrastructure dedicated specifically to DFOS applications, with dual privacy protection.

### SUMMARY OF THE INVENTION

An advance in the art is made according to aspects of the present disclosure directed to an innovative approach to DFOS/AI systems and methods. In sharp contrast to the prior art, our inventive systems and methods employ a specially designed memory-augmented model for fiber sensing recognition equipped with a disaggregated computing infrastructure (DCI) to support the needs for its inference, fine-tuning, and flexible adaptation across a communications network. As we shall show and describe further, our system “Fiber-Mind”, provides dual privacy protection for both service providers and end-users.

As we shall show and describe and in sharp contrast to the prior art, our inventive approach and systems and methods provides the following.

Our inventive approach allows a self-interested client who owns data to collaboratively train models with the provider (server), and as a result, end-users can become both consumers and co-creators of optical fiber sensing AI solutions. Advantageously, an end-user has complete model ownership of the fine-tuned model.

Our inventive approach leverages heterogeneous computing power available on servers and clients. Operationally, we assign different types of computation to different machines. A feature extraction encoder resides on the client-side is assigned to an edge GPU to both protect data privacy and reduce the amount of data movement, and more expensive, large-scale similarity search is assigned to a more powerful machine on the server-side. This is particularly beneficial when a memory bank is large. The overhead can be reduced by properly overlapping the communication round and the computation round. We meticulously designed data movement between CPU/GPU memory and server-client data transport over networking communication protocol (TCP), leveraging modern deep learning frameworks (e.g., PyTorch, TensorFlow, and JAX) and high-performance asynchronous messaging libraries. Our memory-augmented fiber sensing recognition model is hardware-aware, which allow GPU connected to remote memory, thus amendable to more advanced architecture (e.g., GPUDirect RDMA).

Our memory-augmented neural network demonstrates strong generalization performance in both task-incremental and the more challenging class-incremental settings. It enables flexibly adding or deleting classes by modifying the augmented memory without the need of retrain model.

Operationally, our inventive approach provides pre-trained fiber sensing recognition models as an infrastructure or API via optical networks, and allows the end user to perform not only “inference” but also “model updating” by passing a gradient through it. Our disaggregated inference and fine-tuning scheme protects a provider's proprietary training data, safeguards user's sensitive data and model ownership, and also empowers their customization needs.

In contrast to Federated learning (FL), in which distributed models are trained using distributed data, our inventive technique, a model on the server is pertained and we do not allow any model updates on the server model. Instead, we allow users to run through our server model and update their client model by passing gradients returned from the server. Servers can run backpropagation through their layers and return gradient with respect to client embeddings, but they do not update the server-side parameters. Even if client communicates client embeddings to a server, server processes them on the fly and does not save it between successive client requests. In extension to distributed settings, a server can run multiple fine-tuning tasks without them interfering with each other.

Additionally, our disaggregated computing infrastructure (DCI) effectively utilizes heterogeneous, geo-distributed computing resources works across physical boundaries of server-client machines connected by low-latency optical network. Therefore, it achieves better resource efficiency as compared to the prior art. Advantageously, one can implement our approach between data centers (DC) connected by optical networks, and one can use our framework to first establish link between regions according to the cost of electricity or renewable energy, and fine-tune models collaboratively.

Our inventive memory-augmented fiber sensing recognition model enables generalization through memorization. The neural network is explicitly augmented with an external memory, in which the embedding of exemplar samples are stored. When a client edge does not have sufficient processing power, it enables in-context learning on new unseen classes without the need of re-training. It also leads to better recognition performance for rare classes on the long tail, when classification is imbalanced.

Finally, our memory-augmented fiber sensing recognition model simplifies system design by making the client responsible for storing their trainable parameters and do the gradient updates. We employed a special training parallelism for the disaggregated fine-tuning, in which both data and model parallelism is used. The optimization algorithm with data flow and gradient flow is customized with double privacy protection.

### BRIEF DESCRIPTION OF THE DRAWING

FIG. 1(A) and FIG. 1(B) are schematic diagrams showing an illustrative prior art uncoded and coded DFOS systems.

FIG. 2 is a schematic diagram showing illustrative overall architecture of FiberMind, a server-client system that allows geographically disaggregated devices to connect over optical fibers to run fiber sensing recognition tasks and model updates according to aspects of the present disclosure.

FIG. 3 is a schematic diagram showing illustrative framework of disaggregated backpropagation over an optical network module with computation and communication according to aspects of the present disclosure.

FIG. 4 is a schematic diagram showing an illustrative traditional neural network with fixed category, in which the knowledge is stored implicitly in the model weights and bias acquired from training data by gradient descent, according to aspects of the present invention.

FIG. 5 is a schematic diagram showing an illustrative memory-augmented neural network for fiber sensing recognition according to aspects of the present disclosure.

FIG. 6 is a schematic diagram showing illustrative cross-attention layer with key value caching mechanism, and related computation on a server side according to aspects of the present disclosure.

FIG. 7 shows encoder architecture in tabular form according to aspects of the present invention.

FIG. 8 is a schematic diagram showing illustrative server-client disaggregated computational graph (forward pass and backpropagation), derivation over branched pathway according to aspects of the present disclosure.

FIG. 9 shows benchmark classification accuracy and running time in tabular form according to aspects of the present disclosure.

FIG. 10 is a schematic diagram showing illustrative memory augmented network for fiber sensing event classification according to aspects of the present disclosure.

FIG. 11 is a schematic diagram showing illustrative server-side computations according to aspects of the present disclosure.

FIG. 12 is a schematic diagram showing illustrative system architecture of FiberMind which orchestrates computation and communication in which distant data transport passes through two pairs of push-pull sockets, exchanging embedding vectors and their gradients according to aspects of the present disclosure.

FIG. 13 is a schematic diagram showing illustrative server-client disaggregated computational graph (forward pass and backpropagation) in which derivations over model parameters are taken over two branched pathway with partial adjoints added together according to aspects of the present disclosure.

FIG. 14 is a pseudo-code listing of Algorithm 1—disaggregated inference—according to aspects of the present disclosure.

FIG. 15 is a pseudo-code listing of Algorithm 2—disaggregated fine-tuning—according to aspects of the present disclosure.

FIG. 16 shows benchmark classification accuracy averaged over 5 runs in tabular form according to aspects of the present disclosure.

FIG. 17 is a schematic diagram showing an illustrative computer system in which aspects of the present disclosure may be executed according to aspects of the present disclosure.

### DETAILED DESCRIPTION OF THE INVENTION

The following merely illustrates the principles of this disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing (DFOS) systems convert an optical fiber to an array of sensors distributed along the length of the optical fiber. In effect, the optical fiber becomes the array of sensos, while an interrogator generates/injects laser light energy into the optical fiber and senses/detects events along the optical fiber length from backscattered light.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Distributed fiber optic sensing measures changes in “backscattering” of light occurring in an optical sensing fiber when the sensing fiber encounters environmental changes including vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

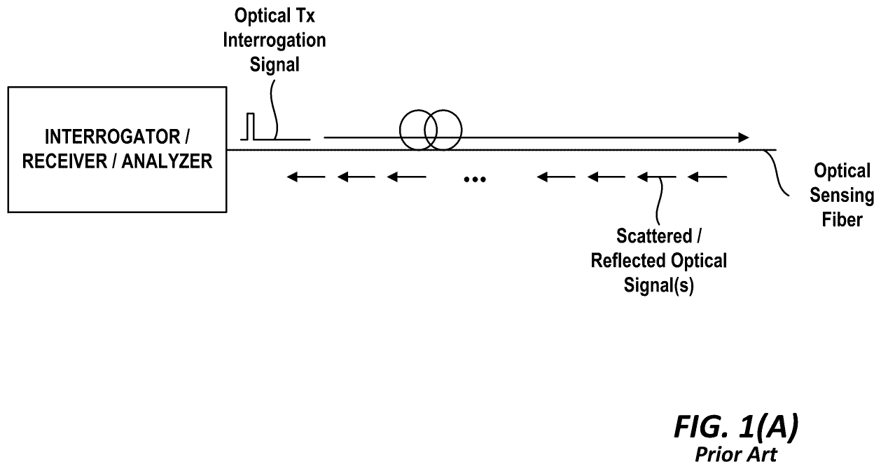

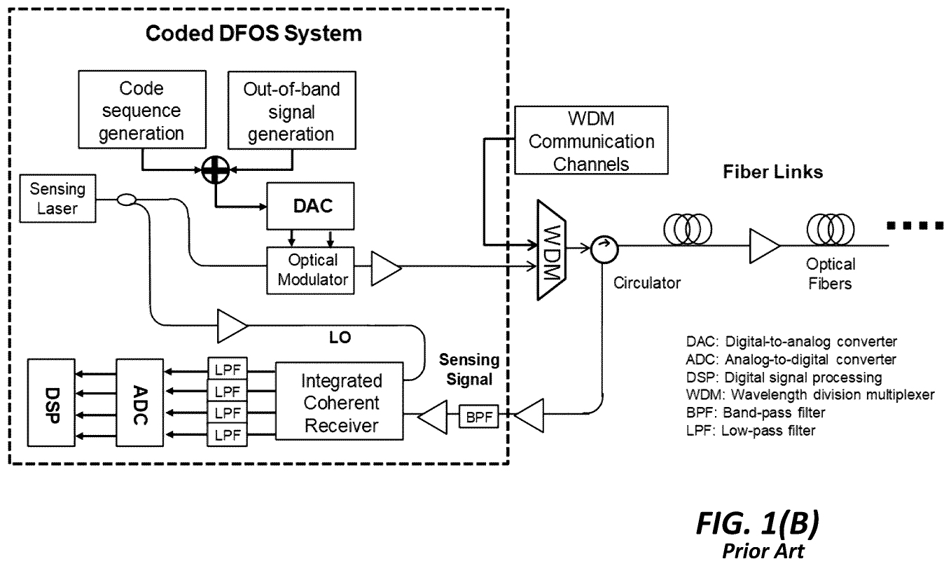

A schematic diagram illustrating the generalized arrangement and operation of a distributed fiber optic sensing system that may advantageously include artificial intelligence/machine learning (AI/ML) analysis is shown illustratively in FIG. 1(A). With reference to FIG. 1(A), one may observe an optical sensing fiber that in turn is connected to an interrogator. While not shown in detail, the interrogator may include a coded DFOS system that may employ a coherent receiver arrangement known in the art such as that illustrated in FIG. 1(B).

As is known, contemporary interrogators are systems that generate an input signal to the optical sensing fiber and detects and/or analyzes reflected and/or backscattered and subsequently received signal(s). The received signals are analyzed, and an output is generated which is indicative of the environmental conditions encountered along the length of the fiber. The backscattered signal(s) so received may result from reflections in the fiber, such as Raman backscattering, Rayleigh backscattering, and Brillion backscattering.

As will be appreciated, a contemporary DFOS system includes the interrogator that periodically generates optical pulses (or any coded signal) and injects them into an optical sensing fiber. The injected optical pulse signal is conveyed along the length optical fiber.

At locations along the length of the fiber, a small portion of signal is backscattered/reflected and conveyed back to the interrogator wherein it is received. The backscattered/reflected signal carries information the interrogator uses to detect, such as a power level change that indicates—for example—a mechanical vibration.

The received backscattered signal is converted to electrical domain and processed inside the interrogator. Based on the pulse injection time and the time the received signal is detected, the interrogator determines at which location along the length of the optical sensing fiber the received signal is returning from, thus able to sense the activity of each location along the length of the optical sensing fiber. Classification methods may be further used to detect and locate events or other environmental conditions including acoustic and/or vibrational and/or thermal along the length of the optical sensing fiber.

Distributed acoustic sensing (DAS) is a technology that uses fiber optic cables as linear acoustic sensors. Unlike traditional point sensors, which measure acoustic vibrations at discrete locations, DAS can provide a continuous acoustic/vibration profile along the entire length of the cable. This makes it ideal for applications where it's important to monitor acoustic/vibration changes over a large area or distance.

Distributed acoustic sensing/distributed vibration sensing (DAS/DVS), also sometimes known as just distributed acoustic sensing (DAS), is a technology that uses optical fibers as widespread vibration and acoustic wave detectors. Like distributed temperature sensing (DTS), DAS/DVS allows continuous monitoring over long distances, but instead of measuring temperature, it measures vibrations and sounds along the fiber.

DAS/DVS operates as follows. Light pulses are sent through the fiber optic sensor cable. As the light travels through the cable, vibrations and sounds cause the fiber to stretch and contract slightly. These tiny changes in the fiber's length affect how the light interacts with the material, causing a shift in the backscattered light's frequency. By analyzing the frequency shift of the backscattered light, the DAS/DVS system can determine the location and intensity of the vibrations or sounds along the fiber optic cable.

DAS/DVS offers several advantages over traditional point-based vibration sensors: High spatial resolution: It can measure vibrations with high granularity, pinpointing the exact location of the source along the cable; Long distances: It can monitor vibrations over large areas, covering several kilometers with a single fiber optic sensor cable; Continuous monitoring: It provides a continuous picture of vibration activity, allowing for better detection of anomalies and trends; Immune to electromagnetic interference (EMI): Fiber optic cables are not affected by electrical noise, making them suitable for use in environments with strong electromagnetic fields.

DAS/DVS technologies have proven useful in a wide range of applications, including: Structural health monitoring: Monitoring bridges, buildings, and other structures for damage or safety concerns; Pipeline monitoring: Detecting leaks, blockages, and other anomalies in pipelines for oil, gas, and other fluids; Perimeter security: Detecting intrusions and other activities along fences, pipelines, or other borders; Geophysics: Studying seismic activity, landslides, and other geological phenomena; and Machine health monitoring: Monitoring the health of machinery by detecting abnormal vibrations indicative of potential problems.

As is known, acoustic signals are produced by numerous events, enabling humans to naturally learn various types of sounds through acoustic sensory experiences. Therefore, acoustic signals are one of the essential factors for real-time awareness of surrounding events, as well as image and video data.

For example, the detection of an explosion sound by our ears can immediately indicate an anomaly. Deploying numerous audio sensors, like electric microphones, over large areas can provide valuable acoustic information for anomaly detection and scene or event recognition. However, this approach is energy-intensive, and these devices may require batteries to operate.

One solution to this issue is to use a distributed fiber-optic sensor. This DFOS technology advantageously converts an optical fiber extending over 10 kilometers into a distributed sensor with a spatial resolution on the order of 1 meter. Specifically—as noted above—a sensor employing phase-sensitive optical time-domain reflectometry (Phase-sensitive OTDR), also known as a Distributed Acoustic Sensor (DAS), can convert mechanical dynamic strains on the fiber, caused by acoustic signals, into phase changes in Rayleigh backscattered light. Consequently, this allows for the monitoring of local acoustic events over very large geographic areas using the optical fiber. Of further advantage, the optical fiber may be a telecommunications-carrying optical fiber, thereby allowing telecommunications traffic and DFOS—simultaneously.

Optical fiber networks, serving as the communication backbone, are extensively and densely deployed worldwide. The widespread of optical fiber infrastructures that telecom carriers have constructed over the past 30 years has been designed accommodating the surge in internet traffic and to facilitate the interconnections of 5G and future networks among cities, town, homes, and data centers.

Distributed Fiber Optic Sensing (DFOS) technology leverages the existing fiber infrastructures as a potential sensing media, enabling a wide-range, real-time, and continuous monitoring of surrounding environment perception without the need to introduce additional sensing devices. DFOS has been successfully employed in diverse applications including road traffic monitoring, intrusion detection, earthquake detection, pipeline leakage monitoring and structure change detection.

Operational telecommunications optical fiber cable networks hold substantial potential for environmental perception and sensing applications. DFOS technology transforms existing communication cables into individual sensors distributed at every meter along the optical fiber cable, with all the measurements being synchronized. As a result, this sensing technology can be employed to detect events related to both infrastructure itself and its surrounding environments.

At this point we note once again that in recent years, distributed fiber optic sensing (DFOS) technology has been used in more and more applications, such as perimeter security, border protection, oil and gas exploration and production, traffic and road monitoring, environment monitoring, natural disaster warning, etc. By analyzing various types of optical backscattering signals (Rayleigh, Brillouin, and Raman), DFOS systems can detect different physical phenomena such as vibration, strain, and temperature over a long distance of optical fiber with fine spatial resolution. These physical data can then be used to extract meaningful events such as intrusion, seismic activity, traffic movement, oil production, construction, etc. The event identification and classification is usually performed using advance machine learning (ML) technologies such as deep neural networks.

Due to the large amount of sensing points in each DFOS system (thousands or more), the high data rate (kilohertz or faster), and the growing complexity of neural network models (with millions to billions of parameters showing improved performance), the real-time data analytic operation for the DFOS system usually requires large-scale, high-speed computation hardware, such as a large GPU cluster, which is typically located in a cloud data center. On the other hand, the end users of the DFOS applications often require data security due to privacy concern and proprietary reason, therefore many users demand on-premises operation and do not allow the field data to be transferred outside their facility.

In addition, the deployed machine learning algorithm is trained by large-amount of proprietary labeled data. It is often against company's interest to release the labeled data to individual customers (not even in its processed form such as embedding vectors). In other words, there are privacy concerns on both the edge side and the cloud side. Real-world deployment of DFOS-AI systems presents additional challenges. Pre-trained models must adapt to constantly changing deployment environments and address the personalized requirements of different use cases.

Practical usage of fiber sensing recognition models can be broadly divided into two main scenarios: inference and adapting pre-trained model to domain-specific tasks. The double privacy preserving issue brings challenges for both recognition (inference) and adaptation (fine-tuning):

Inference only or Training-free: Without updating the model on user newly collected data (from seen classes in new environment, or new categories completely unseen during training), the pre-trained model suffers from inferior performance on classifying events from seen categories and is unable to classify events from unseen categories. Although training-free approach such as TIP-adapter has been proposed in the literature, the classification performance on out-of-domain (OOD) data is sub-optimal. This is due to the constraint of in-context learning (ICL).

Fine-tuning on edge only: End users can choose to fine-tune the pre-trained model on the newly collected data on-premise, however, the model may experience catastrophic forgetting of the old knowledge acquired from pre-training on the large amounts of proprietary labeled data. Therefore, model fine-tuned on edge data only applies to the domain-incremental learning setting (same class, new environment) and task-incremental setting (new class only), not the class-incremental setting (old class and the new class). In the latter setting, an algorithm must incrementally learn to distinguish between a growing number of events.

Nowadays, usually there are processing power on each on-premises system (edge) to support ML inference. The typical choice is to only allow users to do inference over pre-defined categories (on the edge), in which the knowledge about the pre-trained data implicitly stored in the model weights of the neural network. Obviously, this choice severely limits the generalization and flexibility of the DFOS-AI system.

First, as DFOS being deployed to more and more routes, the AI system shall effectively cumulate the knowledge about new deployment environments and make the recognition abilities of the AI system also improve with experience.

Second, the customization and personalization needs of different use case has been increasing unprecedentedly, and one often needs to add new classes or delete old ones from the pre-trained model. For example, an indoor use case may not require classification capabilities of underwater events. Hotel users may want to add new classes related to a new type of vacuum cleaner or loud TV sounds, to the existing classes of gunshot, yelling, or wood break sounds. However, this typically requires re-training the model from scratch. Without access to both the provider's data and the newly collected data from the user at one place, this cannot be done either on the edge or in the cloud.

Ideally, the AI systems should allow new classes to be introduced while retain knowledge of all previously learned classes, or selectively forget knowledge from irrelevant classes. As DFOS AI service provider, one shall offer a cost-effective solution to protect the user privacy, confidential proprietary training data of provider, while empower user customization needs. Methods and infrastructure for disaggregated inference and fine-tuning of pre-trained fiber sensing models are needed, which can leverage geo-distributed and interconnected computing resources thereby reducing the energy costs, accelerate the training cycle by reducing the latency, alleviate network bandwidth requirements, and enable more cost-effective solutions.

With the growing demand for accurate machine learning models, increasing data size, and more complex deep learning architectures, proposals for dynamically reconfigurable physical layers have emerged to enable high throughput, low latency, and seamless failure recovery. These approaches aim to enhance efficiency and reduce the cost of large-scale AI networks. There are also proposals of distributed inference and fine-tuning of large language models (LLM) over decentralized system involving geo-distributed devices connected via the Internet. While these efforts focus on architectures for generic applications or general purpose algorithms, the rapidly expanding DFOS market necessitates urgent consideration of computing and networking infrastructure dedicated specifically to DFOS applications, with dual privacy protection.

We describe a specially designed memory-augmented model for fiber sensing recognition equipped with a disaggregated computing infrastructure (DCI) to support the needs for its inference, fine-tuning, and flexible adaptation across the communication network. Our system, Fiber Mind, is addresses this issue by providing dual privacy protection for both the service provider and the end-user. Besides, it also has the following features:

Our framework allows self-interested client who owns data to collaboratively train models with the provide (server), and as a result, end-users can become both consumers and co-creators of fiber sensing AI solutions. And the end-user has complete model ownership of the fine-tuned model.

It also leverages heterogeneous computing power available on server and client sides. We assign different types of computation to different machines. The feature extraction encoder sits on the client-side is assigned to edge GPU to both protect data privacy and reduce the amount of data movement, and the more expensive large-scale similarity search is assigned to the more powerful machine on the server-side. This is particularly beneficial when the memory bank is large. The overhead can be reduced by properly overlapping the communication round and the computation round. We meticulously designed data movement between CPU/GPU memory and server-client data transport over networking communication protocol (TCP), leveraging modern deep learning frameworks (e.g., PyTorch, TensorFlow, and JAX) and high-performance asynchronous messaging library. Our memory-augmented fiber sensing recognition model is hardware-aware, which allow GPU connected to remote memory, thus amendable to more advanced architecture (e.g., GPUDirect RDMA).

The memory-augmented neural network demonstrates strong generalization performance in both task-incremental and the more challenging class-incremental settings. It enables flexibly adding or deleting classes by modifying the augmented memory without the need of retrain model.

We provide pre-trained fiber sensing recognition model as an infrastructure or API via optical networks, and it can allow the end user to do not only “inference” but also “model updating” by passing gradient through it. Our disaggregated inference and fine-tuning scheme protects provider's proprietary training data, safeguards user's sensitive data and model ownership, and also empowers their customization needs.

Different from Federated learning (FL), in which distributed models are trained using distributed data, the model on the server has been pertained and we do not allow any model updates on the server model. Instead, we allow users to run through our server model and update their client model by passing gradients returned from the server. Servers can run backpropagation through their layers and return gradient with respect to client embeddings, but they do not update the server-side parameters. Even if client communicates client embeddings to a server, server processes them on the fly and does not save it between successive client requests. In extension to distributed settings, a server can run multiple fine-tuning tasks without them interfering with each other.

Our disaggregated computing infrastructure (DCI) effectively utilizes heterogeneous, geo-distributed computing resources works across physical boundaries of server-client machines connected by low-latency optical network. Therefore, it can achieve better resource efficiency. It is possible to implement our approach between data centers (DC) connected by optical networks. One can use our framework to first establish link between regions according to the cost of electricity or renewable energy, and fine-tune models collaboratively.

Our memory-augmented fiber sensing recognition model enables generalization through memorization. The neural network is explicitly augmented with an external memory, in which the embedding of exemplar samples are stored. When client edge does not have sufficient processing power, it enables in-context learning on new unseen classes without the need of re-training. It also leads to better recognition performance for rare classes on the long-tail when classification is imbalanced.

Our memory-augmented fiber sensing recognition model simplifies the system design by making the client responsible for storing their trainable parameters and do the gradient updates. We employed a special training parallelism for the disaggregated fine-tuning, in which both data and model parallelism is used. The optimization algorithm with data flow and gradient flow is customized with double privacy protection

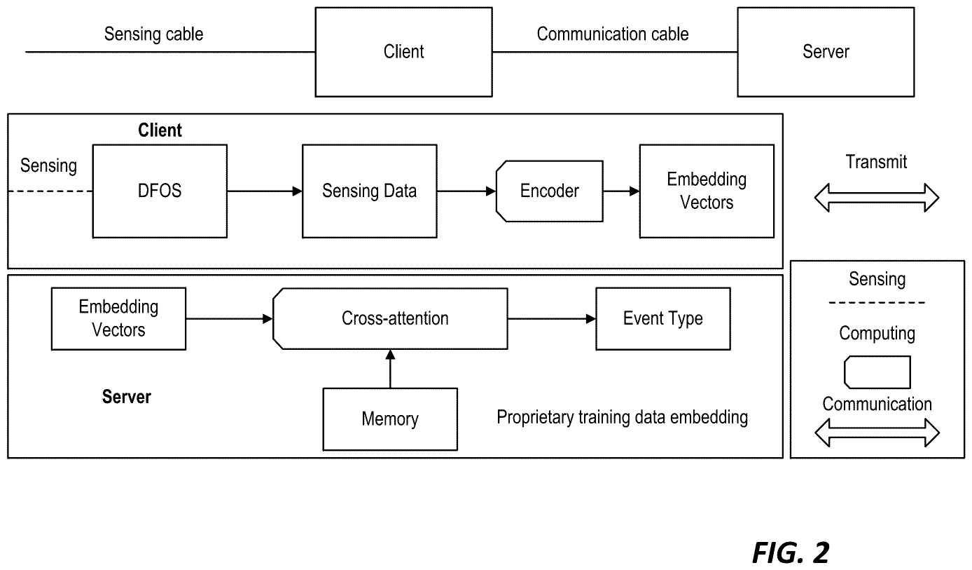

FIG. 2 is a schematic diagram showing illustrative overall architecture of FiberMind, a server-client system that allows geographically disaggregated devices to connect over optical fibers to run fiber sensing recognition tasks and model updates according to aspects of the present disclosure.

It involves a sensing cable connects to the client edge site and the communication cable connects the client to the server. The computing units are denoted in gray shade. The data is collected by the DFOS units over sensing cable, and the fiber sensing machine learning model for event classification involves computation from both sides, connected by a communication cable.

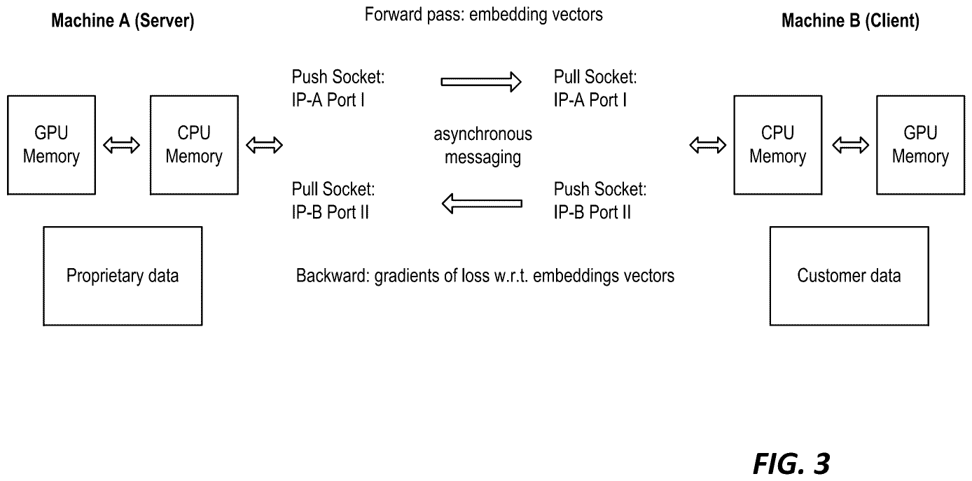

We describe a simple yet effective framework, as is shown in FIG. 3, which is a schematic diagram showing illustrative framework of disaggregated backpropagation over an optical network module with computation and communication according to aspects of the present disclosure.

The training workloads is handled by the disaggregated backpropagation over optical network module we designed, which is compatible with the Autograd engine from modern deep learning frameworks. We use the pipeline pattern for messaging handling with push-pull with automatic load balancing, fault tolerance, and queueing and message buffering.

In our design, company proprietary dataset used in pre-training and customer dataset sits on distant places. In the pre-computing cycle, the encoding of proprietary data is done on the server-side. In each forward pass, the encoding of customer data is on the client-side. The similarity-based classification and loss computation are on the server-side. In the backward pass, the gradient computing with respect to client embedding are on the server-side. The gradient computation for encoder parameters and the actual parameter updates happens on the client-side.

Our invention includes both model architecture and on top it, the disaagreated computing system termed FiberMind. We will introduce them separately.

### Part 1: Memory-Augmented Neural Network Architecture for Fiber Sensing Recognition

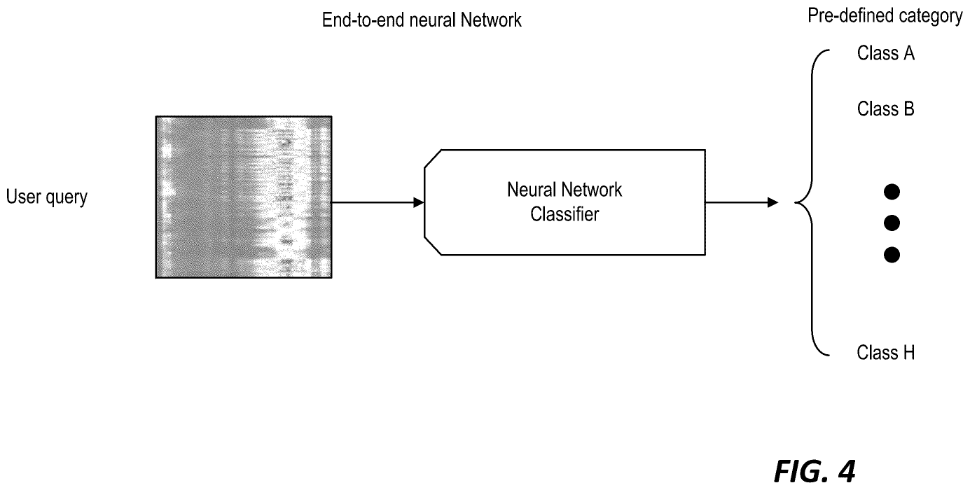

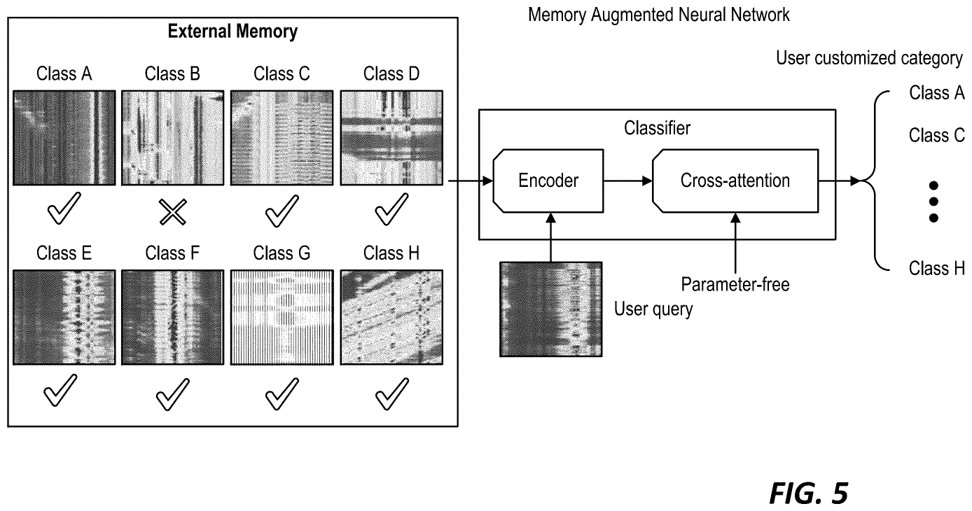

We compare our proposed memory-augmented neural network architecture for fiber sensing recognition showing in FIG. 4, which is a schematic diagram showing an illustrative traditional neural network with fixed category, in which the knowledge is stored implicitly in the model weights and bias acquired from training data by gradient descent, according to aspects of the present invention, with the traditional neural network shown in FIG. 5. which is a schematic diagram showing an illustrative memory-augmented neural network for fiber sensing recognition according to aspects of the present disclosure.

In our inventive memory network architecture, the knowledge is stored both implicitly in the model parameters of encoder and explicitly in the memory in the form of vector embeddings. As a result, user can flexibly define a category by masking the embedding from certain unwanted classes during test-time (e.g., Class B). The classification is done by comparing the similarity between the embedding of query image and embedding of support images in the cross-attention module. There is no parameter that needs to be learn in the cross-attention module

### 1.1 Cross-Attention Module

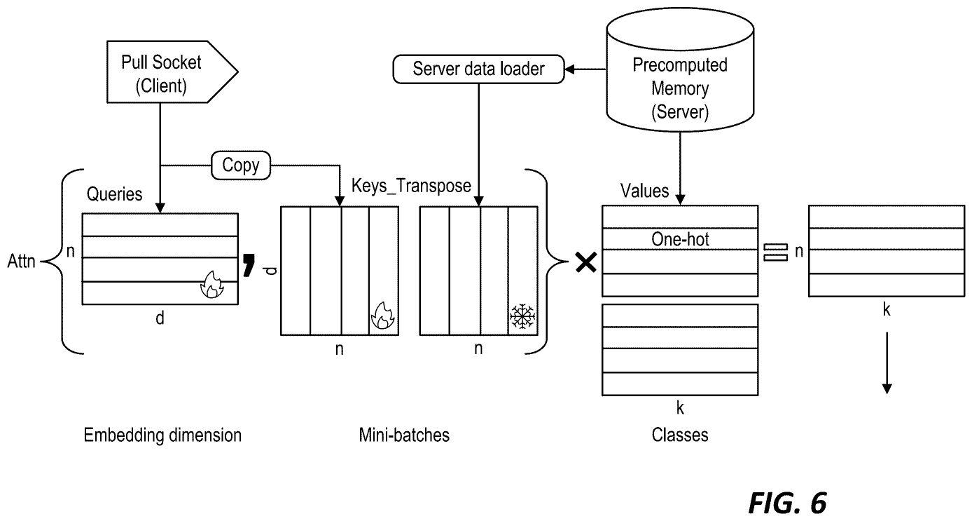

FIG. 6 is a schematic diagram showing illustrative cross-attention layer with key value caching mechanism, and related computation on a server side according to aspects of the present disclosure.

The n×d client embedding vectors are pulled from the client socket, and one copy of it serves as query, and another copy of it serves as part of the key. Both copies requires gradients. The another part of key comes from the precomputed memory on the server-side, arranged by a data loader in mini-batches. This part is frozen which does NOT require gradients. The values are one-hot vectors indicate the class membership. The similarity is computed under L2 distance, and then normalized with softmax operator. The classification prediction is obtained by batched matrix multiplication of the attention matrix and the value matrix.

### 1.2 Encoder Module

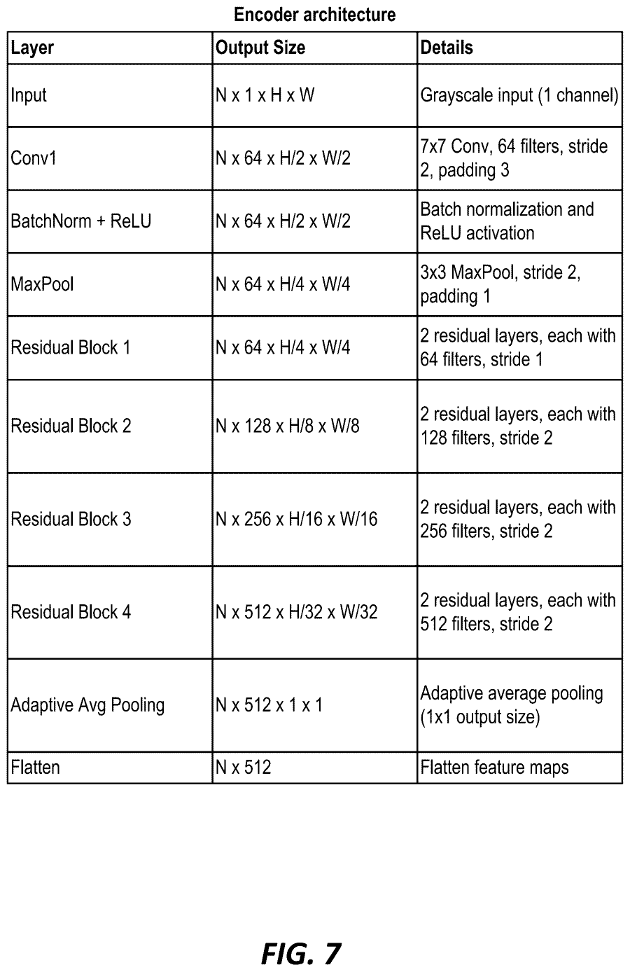

For example, the encoder can be a four-layer ResNet (detailed in FIG. 7, which shows encoder architecture in tabular form according to aspects of the present invention) for feature extraction, and other architecture is applicable as well.

The encoder is also used to obtain the embedding vectors in the external memory. The external memory allow user to specify which classes should be considered in their updated version of the model without re-training. As a result, users can rapidly switch classes between different use cases. Similarly, it also allows the model prediction to be influenced by newly added exemplars (e.g., confirmed historical cases) in the memory bank, allowing test-time adaptation in which novel samples are rapidly assimilated

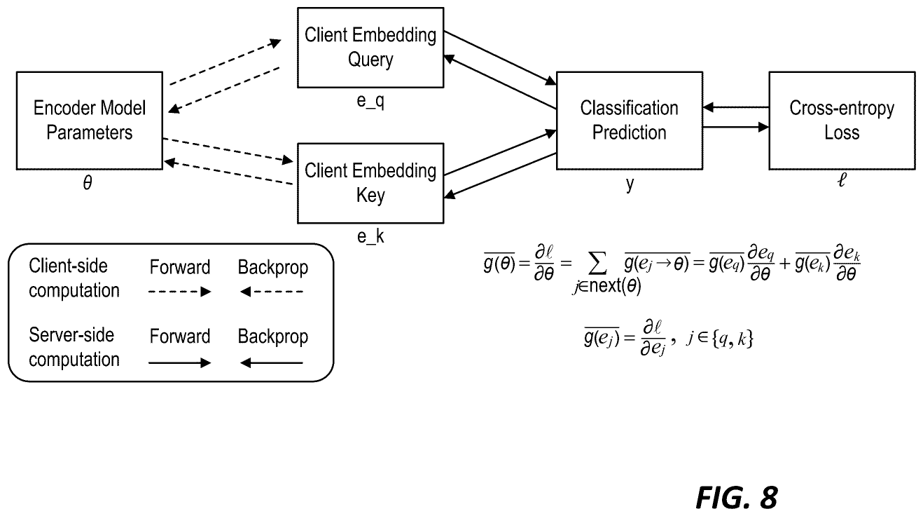

FIG. 8 is a schematic diagram showing illustrative server-client disaggregated computational graph (forward pass and backpropagation), derivation over branched pathway according to aspects of the present disclosure.

FIG. 8 illustrates the computational graph, in which forward passes are denoted in blue color, and backpropagations are denoted in red color. Operations on the server-side are denoted in solid lines, and operations on the client-side are denoted in dash lines. Since embedding vectors are being used in both query and key, the gradient of loss w.r.t. model parameters in the encoder depends on two partial adjoints that are computed separately, and then summed together.

### Part 2: Disaggregated Inference and Fine-Tuning Based on the FiberMind System

### Disaggregated Inference (One Forward Pass Only):

### Machine A (Server):

Initialization: Company collected proprietary labeled dataset {z, l}, pre-trained model θ₀, and pre-computed embedding e_{z}=encoder(z, θ₀)
[Server] Step 1: Receive {e_{q}} from client
[Server] Step 2: Given {e_{q}}, and {e_{z}, l}, make the prediction of label y by computing the dot-product and normalize by softmax, and then make a weighted combination of one-hot encoding of the label l.

### Machine B (Client):

Initialization: User query {q}, pretrained model θ₀ (or fine-tuned model θ_{T})
[Client] Step 1: Given the model θ₀ or θ_{T}, compute embedding e_{q}=encoder(q, θ₀) or e_{q}=encoder(q, θ_{T}) (inference with the fine-tuned model)
[Client] Step 2: Send {e_{q}} to server

If newly collected data is not available, user just need to send the query to the server for inference. Otherwise, the embedding of newly collected data needs to be sent to the server as well. This is a one-time operation at the beginning of the inference. These embeddings can facilitate in-context learning. Since it is training-free, no GPU needed on the edge.

### Disaggregated Fine-Tuning (Forward and Backward Pass Iteratively):

### Machine a (Server):

Initialization: Company collected proprietary labeled dataset S={z, l}, pretrained model θ₀, pre-compute embedding e_{z}=encoder(z, θ₀)
[Server] Step 1: Receive {eₓ} from client, assembly with predefined y
[Server] Step 2: Given {eₓ, y}, and {e_{z}, l}, compute cross-attention and the loss,
[Server] Step 3: Compute gradient \{gₑ_{ₓ}} of the loss to eₓ
[Server] Step 4: Send the gradient \{gₑ_{ₓ}} to client

### Machine B (Client):

Initialization: User collected labeled dataset T={x, y}, a dataloader
[Client] Step 1: Given model θₜ, compute embedding eₓ=encoder(x, θₜ)
[Client] Step 2: Send {eₓ} to server
[Client] Step 3: Receive gradients \{gₑ_{ₓ}}
[Client] Step 4: Compute gradient wr.t. θ via backpropagation
[Client] Step 5: Locally updated model θₜ₊₁

Cycle through back and forth until converge, GPU needed on the edge. Save the fine-tuned model θ_{T}.

As can be seen, the server-side never releases the labeled proprietary training data, not even in the form of vector embeddings, while the client retains full ownership of the privately fine-tuned model θ_{T}. Only mini-batches of embeddings {eₓ} are transmitted from the client to the server, where they are processed on the fly without being stored. The server returns the gradients \{gₑ_{ₓ}} to the client. Notably, even the labels for the client embeddings do not need to be sent in communication rounds, as they can be predefined in a sequence like 0, 0, 0, 1, 1, 1, 2, 2, 2, etc., following a predefined order and repeating pattern. The customized dataloader always prepares data in this order.

Optionally, we benchmark in a real-world single node server-client setting, in which two machines are connected via an optical link. The specs for the two machine are as follows:

### Machine A (Server Workstation):

OS: Ubuntu 18.04.6 LTS
CPU: Intel Core i7-9800X 8C 3.8-4.4 GHz
Memory: 32 GB DDR 4 3200 (2x16 Gb) (128 Gb)
GPU: NVIDIA GeForce RTX-2080Ti (11 Gb)

### Machine B (Client Laptop):

OS: Windows 11 Pro
CPU: Intel Core i9-24-Core 2.2 GHz
Memory: 32 GB DDR5
GPU: NVIDIA GeForce RTX-4080 (12 Gb)

Dataset: We use waterfall data collected from the field. The dataset contains 32 classes, each has 200 samples. We selected 16 classes for pre-training and put them on the server machine and held out the other 16 classes as new unseen dataset and put on the client-machine. We split 150 samples per class for training, and 50 samples per class for test. For all experiments, the model is trained 100 epochs using Adam optimizer with learning rate 1e−4, the batch size is 32.

In the test, we consider three settings:
A: in-domain classification of the 16 seen classes,
B: task-incremental classification of the 16 unseen classes, and
C: class-incremental classification of all 32 classes,

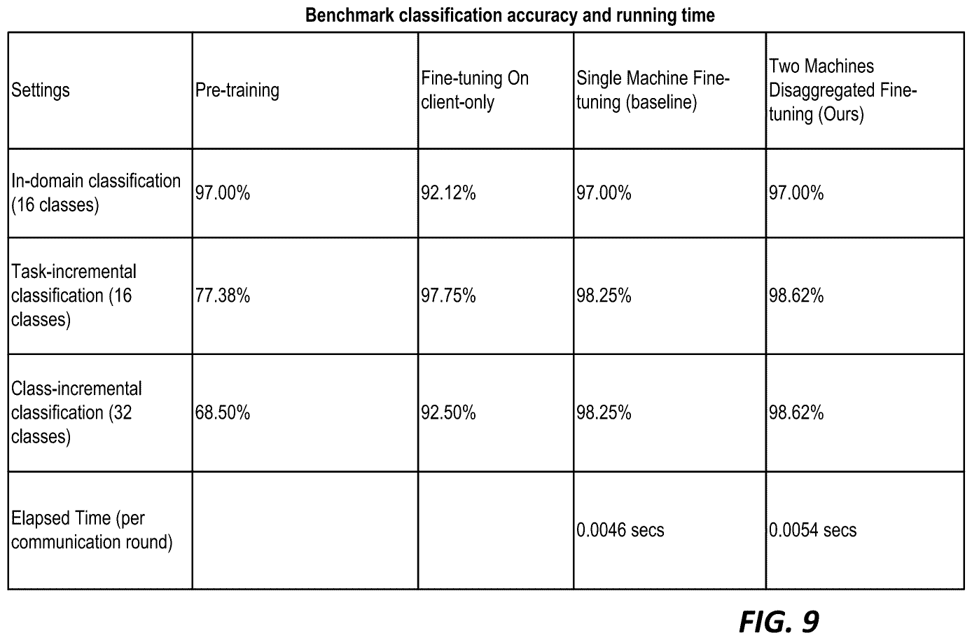

FIG. 9 shows benchmark classification accuracy and running time in tabular form according to aspects of the present disclosure.

From the table in FIG. 9, we observe that
i) Edge fine-tuning with customer data only improves 16-class classification accuracy from 77.38% to 97.75% in the task-incremental setting. However, the in-domain 16-class classification accuracy decreases from 97% to 92.12%. This suggests that access to the host data is also needed for the fine-tuning.
ii) In the most challenging class-incremental setting, the classification accuracy of the pre-trained model is only 68.50%. This suggested that the training-free approach (in-context learning) is not enough for AI to work on both new and old classes. Fine-tuning is needed.
iii) by fine-tuning with proprietary data, the accuracy increases to 92.50%, and by using both customer data and proprietary data, the accuracy increase to 98.25% on single machine two GPU (one mimic the client, and one mimic the server) without data privacy, and 98.62% across the proposed one server-client DCI platform with doubly privacy protection.
iv) despite the fact that the fine-tuning is informed by the embedding vector of the pre-trained model only, the model can successfully adapt to new class while retaining its performance on the old classes (No catastrophic forgetting happened).
v) compared to the single machine case as a baseline, the computation overhead is only 8.191 ms per communication round (without extensive optimization and network engineering).

As we have noted, advanced machine learning (ML) models, such as deep neural networks, are used for event recognition, identifying meaningful events from sensing data that capture various physical phenomena—such as vibration, strain, and temperature—over long distances of optical fiber with fine spatial resolution. Real-world deployment of DFOS-AI systems often involves not only the inference task, where the pre-trained model is used to classify events from categories encountered during training, but also the capability of fine-tuning the model to meet personalization needs in various use cases, such as adding new event categories of interest and making the model generalized to new deployment environments.

Typically, updating the pre-trained model requires access to labeled data from both the end user and the provider at one place. However, the end users of DFOS applications usually require data security due to privacy concern and proprietary reason; therefore, many users demand on-premises operation and do not allow the field data to be transferred outside their facilities. At the same time, there are restrictions from the provider on releasing large amounts of proprietary labeled data (or its processed form) to the end user as well. These factors create a challenge of double privacy protection. Fine-tuning only with the limited amount on-premise data may cause catastrophic forgetting of the valuable knowledge acquired during pre-training and leads to suboptimal performance.

To handle the increasing data and model size, optical network interconnects are being proposed to enhance efficiency and reduce costs in generic large-scale AI applications [8, 9]. For large language models, a general-purpose algorithm has been proposed for inference and fine-tuning in a distributed setting with fault tolerance. The rapidly expanding DFOS market necessitates urgent consideration of machine learning model architecture, as well as computing and networking infrastructure dedicated specifically to fiber sensing recognition applications. As DFOS-AI service provider, one shall offer a cost-effective solution that protects the data privacy and model ownership of users, safeguards the provider's confidential proprietary training data, and empowers user customization needs.

To address these challenges, we have disclosed FiberMind, a server-client disaggregated computing system that allows geo-distributed machines connected over a optical fiber to run fiber sensing recognition and adaptation tasks collaboratively. We benchmark the performance of the proposed approach using field collected DFOS data and a real-world testbed with server-client machines connected by a 120 km of optical link. Our work enables dataowner (client) to collaboratively train models with the provide (server), allowing end-users to be both consumers and co-creators of DFOS-AI solutions.

### Method

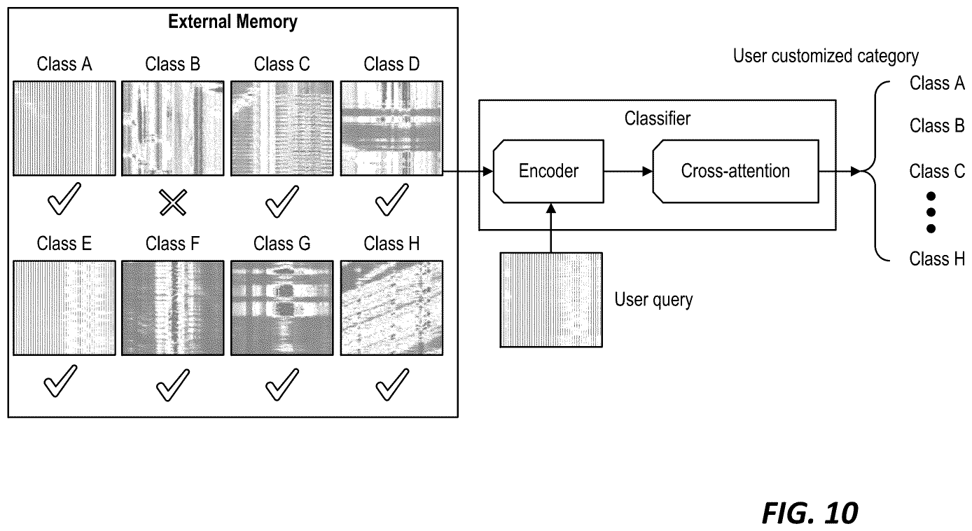

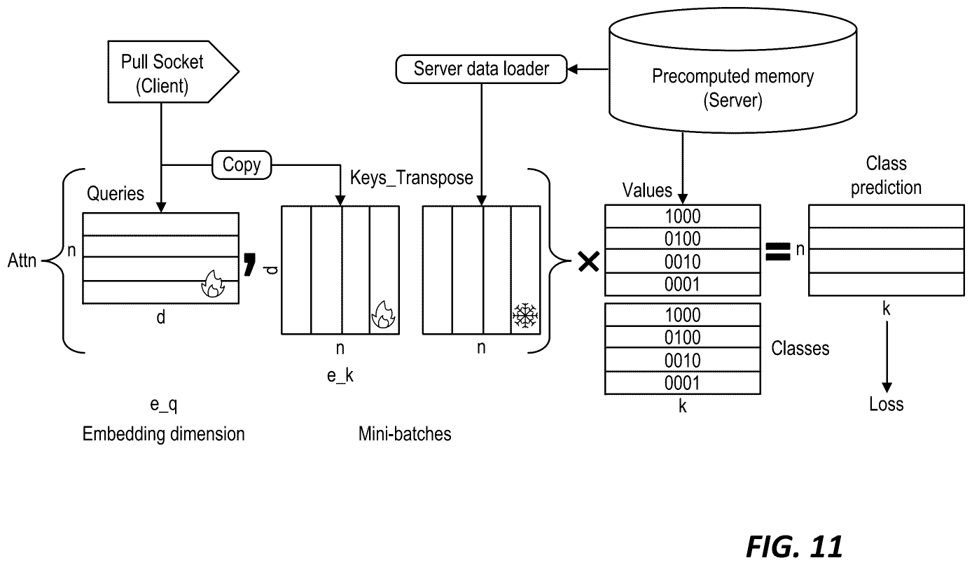

We consider a neural network augmented with an external memory detailed in FIG. 10, which is a schematic diagram showing illustrative memory augmented network for fiber sensing event classification according to aspects of the present disclosure; and FIG. 11, which is a schematic diagram showing illustrative server-side computations according to aspects of the present disclosure.

Traditional neural networks are trained with fixed categories, with knowledge implicitly stored in the model parameters that is not convenient for adaptation. In contrast, memory networks store part of the knowledge explicitly in the memory in the form of vector embeddings. Classification is done by comparing the similarity between the embedding of the query image and the embeddings of the exemplar images in a parameter-free cross-attention module. During test-time, the content of memory can be flexibly modified by adding new confirmed classes or masking out unwanted ones.

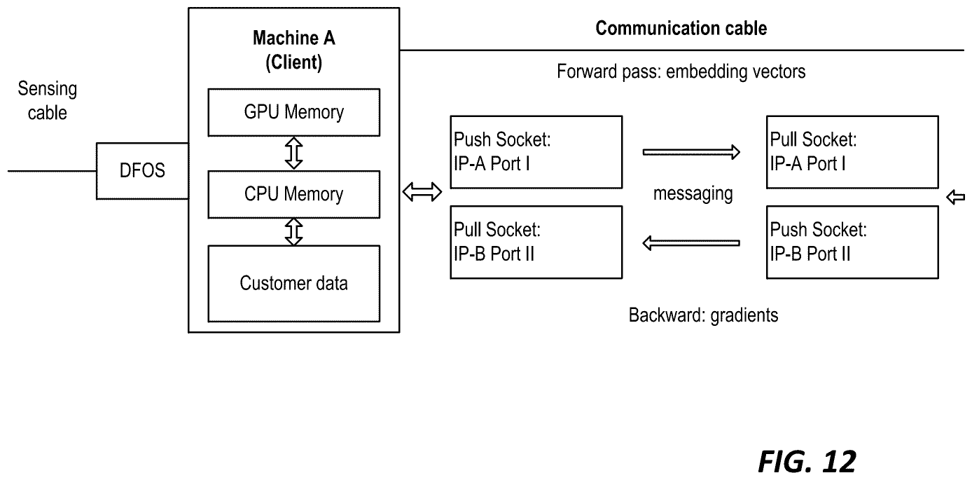

The memory network is hosted on the proposed FiberMind system, (illustrated in FIG. 12, which is a schematic diagram showing illustrative system architecture of FiberMind which orchestrates computation and communication in which distant data transport passes through two pairs of push-pull sockets, exchanging embedding vectors and their gradients according to aspects of the present disclosure) with the external memory located remotely on the server side and the fine-tuned encoder stored on the client side. The data is collected by the DFOS units over a sensing cable. FiberMind effectively utilizes heterogeneous, geo-distributed computing resources connected by a low-latency communication cable. The encoder feature extraction is assigned to client GPU for protecting data privacy and reducing data movement, while the more expensive large-scale similarity search is assigned to the more powerful machine on the server side. This setup is particularly beneficial when the external memory is large. The overhead can be reduced by properly overlapping the communication round and the computation round. We meticulously designed data transport between CPU-GPU memory, leveraging the Autograd engine from modern deep learning frameworks (e.g., PyTorch, TensorFlow, and JAX) and high-performance asynchronous messaging library (e.g., ZeroMQ).

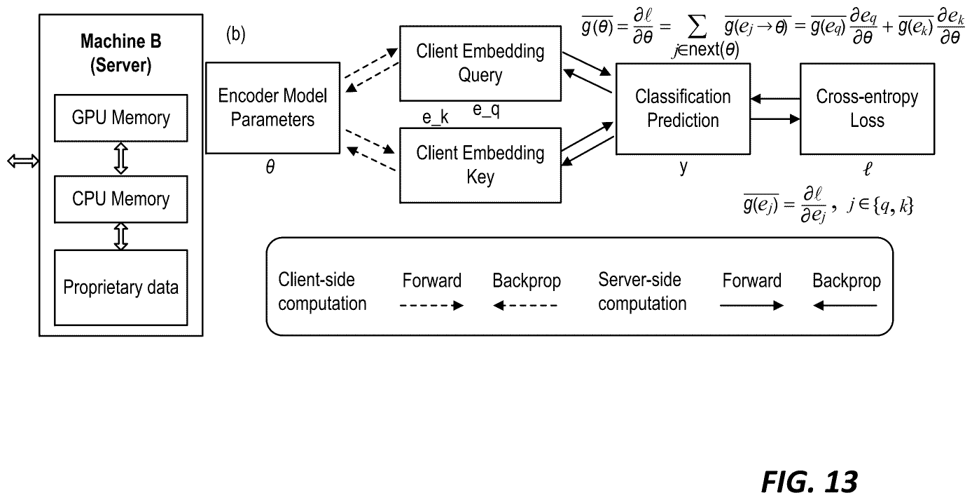

The computational graph is divided across server side and client side is illustrated in FIG. 13, which is a schematic diagram showing illustrative server-client disaggregated computational graph (forward pass and backpropagation) in which derivations over model parameters are taken over two branched pathway with partial adjoints added together according to aspects of the present disclosure.

Unlike standard distributed machine learning training schemes, we do not allow any model updates on the server model. Instead, users can run through our server model via an API call and update their client model with gradients returned from the server. Although client sends mini-batches of client embeddings to the server, the server processes them on the fly and does not save them between successive client requests. This design enables an extension to distributed settings [10], allowing for multiple fine-tuning tasks without interfering with each other.

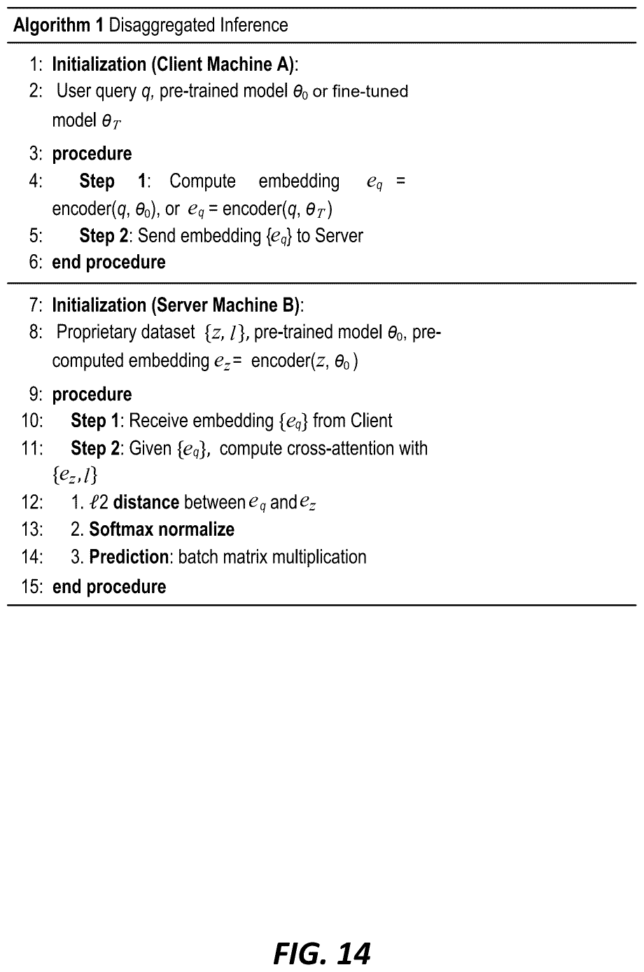

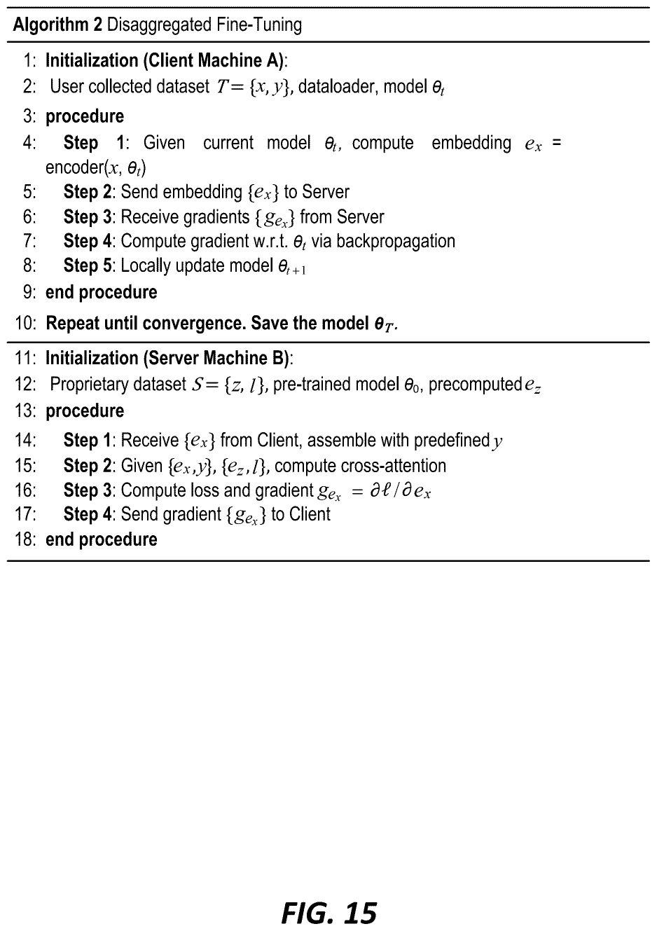

The disaggregated inference (one forward pass only) and fine-tune algorithms are detailed in Algorithm 1 and Algorithm 2, shown in FIG. 14, which is a pseudo-code listing of Algorithm 1—disaggregated inference—according to aspects of the present disclosure, and FIG. 15, which is a pseudo-code listing of Algorithm 2—disaggregated fine-tuning—according to aspects of the present disclosure. As can be seen, the server-side never releases the labeled proprietary training data, not even in the form of vector embeddings, while the client retains full ownership of the privately fine-tuned model.

### Results

Experimental Setup We benchmark in a real-world single node server-client setting, in which two machines are connected via an optical link. The specs for the two machine are as follows: Machine A (Client Laptop): Intel Core i9-24C (2.2 GHz) CPU, 32 GB DDR5 Memory, NVIDIA GeForce RTX-4080 (12 Gb) GPU. Machine B (Server Workstation): Intel Core i7-9800X 8C (3.8-4.4 GHz) CPU, 4×32 GB DDR4 Memory, 2×NVIDIA GeForce RTX-2080Ti (11 Gb) GPU.

Dataset We use waterfall data collected from the field, consisting of 32 classes with 200 samples each. We selected 16 classes as in-domain data for pre-training and put them on the server side, and held out the other 16 classes as new unseen datasets in the task-incremental setting on the client side. Each class is split into 150 training samples and 50 test samples. The class-incremental setting involves all 32 classes. All experiments are conducted over 100 epochs using the Adam optimizer with a learning rate of 1e−4 and a batch size of 32. Baselines include (1) Pre-training with server data only; (2) Fine-tuning with client-data only; (3) Single machine with 2 GPUs using both server and client data (for reference); (4) Server-client over an optical link. Encoder uses a 4 layer ResNet with input image size 128×128. Fine-tuning the model on the dataset requires 906M of GPU memory.

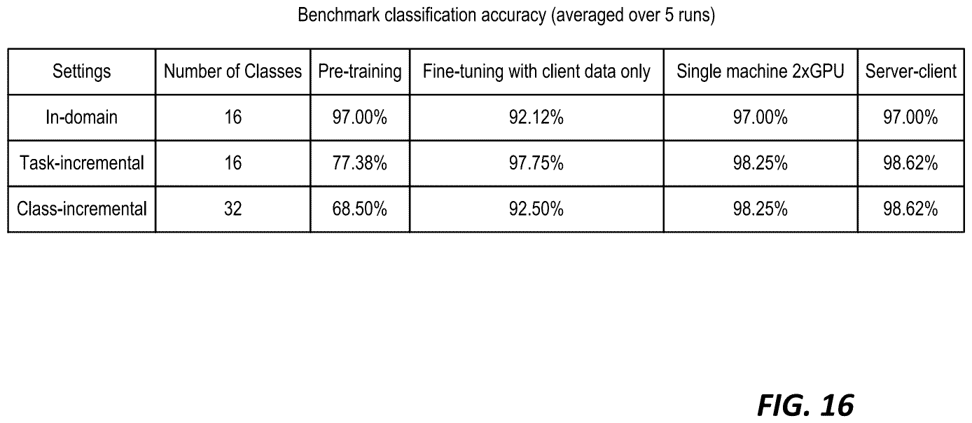

FIG. 16 shows benchmark classification accuracy averaged over 5 runs in tabular form according to aspects of the present disclosure. The table shown in the figure shows that fine-tuning with customer data improves performance over pre-trained model only in the task-incremental setting, highlighting the need for access to the proprietary data on the server. Using both customer and proprietary data, the accuracy increase to 98.25% on the single machine baseline (without data privacy) and achieves comparable results of 98.62% on the proposed server-client platform with doubly privacy protection, with computation overhead of 8.191 ms per communication round—without extensive network engineering.

As our experimental evaluation shows, optical network infrastructure holds great potential for both general-purpose AI scaling and customized designs for mission-critical applications. We propose a privacy-aware machine learning model equipped with a resource efficient disaggregated computing platform for fiber sensing recognition. Our work complements other privacy preserving

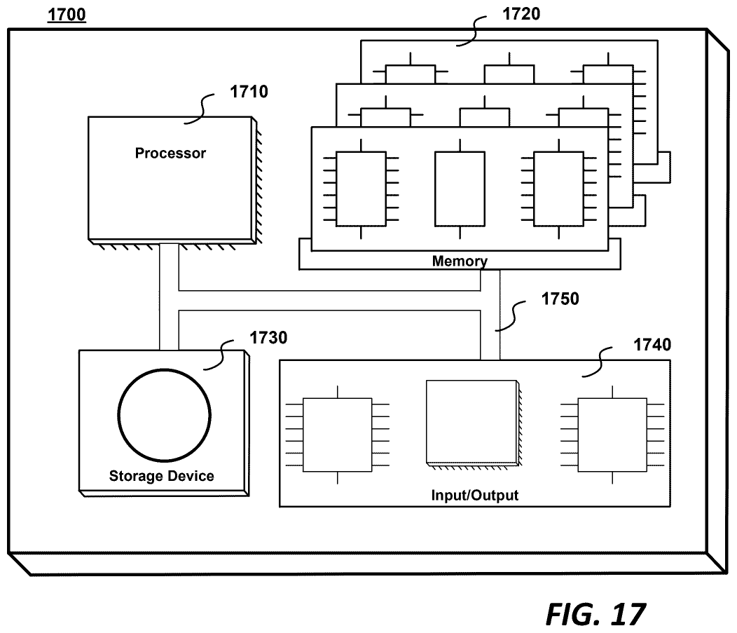

Finally, FIG. 17 is a schematic block diagram of an illustrative computing system that may be programmed with instructions that when executed produce the methods/algorithms according to aspects of the present invention.

As may be immediately appreciated, such a computer system may be integrated into another system such as a router and may be implemented via discrete elements or one or more integrated components. The computer system may comprise, for example, a computer running any of several operating systems. The above-described methods of the present disclosure may be implemented on the computer system 1700 as stored program control instructions.

Computer system 1700 includes processor 1710, memory 1720, storage device 1730, and input/output structure 1740. One or more input/output devices may include a display. One or more busses 1750 typically interconnect the components, 1710, 1720, 1730, and 1740. Processor 1710 may be a single or multi core. Additionally, the system may include accelerators etc., further comprising a system on a chip.

Processor 1710 executes instructions in which embodiments of the present disclosure may comprise steps described in one or more of the Drawing figures. Such instructions may be stored in memory 1720 or storage device 1730. Data and/or information may be received and output using one or more input/output devices.

Memory 1720 may store data and may be a computer-readable medium, such as volatile or non-volatile memory. Storage device 1730 may provide storage for system 1700 including for example, the previously described methods. In various aspects, storage device 1730 may be a flash memory device, a disk drive, an optical disk device, or a tape device employing magnetic, optical, or other recording technologies.

Input/output structures 1740 may provide input/output operations for system 1700.

At this point, those skilled in the art will understand that while we have presented our inventive concepts and description using specific examples, our invention is not so limited. Accordingly, the scope of our invention should be considered in view of the following claims.

1. A disaggregated computing system for memory-augmented fiber sensing recognition and adaptation, the system comprising:
a client machine, geographically separated from a server machine and configured to receive fiber sensing data, the client machine including
a feature extraction encoder having trainable client-side parameters;
the server machine, configured to host:
an external memory bank storing pre-computed vector embeddings of proprietary training data; and
a similarity-based classification module configured to perform classification by comparing a similarity between a query embedding and the pre-computed vector embeddings; and
a communication link connecting the client machine and the server machine, wherein the system is configured to perform a disaggregated backpropagation fine-tuning by:
computing an embedding of the fiber sensing data using the encoder and transmitting the embedding to the server machine;
computing a gradient of a loss function with respect to the embedding on the server machine, wherein server-side parameters are not updated; and
transmitting the gradient to the client machine and updating the client-side parameters of the encoder based on the received gradient, thereby maintaining double privacy protection for the proprietary training data on the server and the fiber sensing data on the client.

2. The system of claim 1, wherein the double privacy protection includes the server machine processing the received embedding on the fly without storing the embedding between successive client requests, thereby preventing the server from retaining user-specific data.

3. The system of claim 1, wherein the client machine utilizes an edge Graphical Processing Unit (GPU) for the feature extraction encoder, and the server machine utilizes a more powerful computing resource for the similarity-based classification module.

4. The system of claim 1, wherein the memory-augmented neural network architecture enables generalization performance in a class-incremental setting by allowing the client machine to adapt to both previously learned classes and newly introduced classes without catastrophic forgetting.

5. The system of claim 1, wherein the external memory bank allows for flexibly adding or deleting classes by modifying the augmented memory content without requiring retraining of the feature extraction encoder.

6. A method for adapting a fiber sensing recognition model using disaggregated computing with double privacy protection, the method comprising:
receiving raw fiber sensing data at a client machine having a feature extraction encoder with trainable client-side parameters;
computing an embedding vector of the raw fiber sensing data using the feature extraction encoder at the client machine;
transmitting the embedding vector to a server machine hosting an external memory bank containing proprietary data embeddings;
at the server machine, computing a loss based on the transmitted embedding vector and the proprietary data embeddings via a similarity-based classification operation, and generating a gradient vector of the loss with respect to the embedding vector;
transmitting the gradient vector from the server machine back to the client machine; and
at the client machine, performing backpropagation using the gradient vector to locally update the trainable client-side parameters of the feature extraction encoder, wherein the server machine does not update any server-side parameters based on the received gradient, and the server machine does not store the embedding vector between successive transmissions.

7. The method of claim 6, wherein the fiber sensing data comprises Distributed Acoustic Sensing (DAS) waterfall data.

8. The method of claim 6, further comprising: a. Initializing the external memory bank on the server machine with vector embeddings pre-computed from the proprietary training data; and b. Freezing the external memory bank such that its contents are not updated during the model adaptation.

9. The method of claim 6, wherein the disaggregated backpropagation fine-tuning includes utilizing both data parallelism and model parallelism between the client machine and the server machine.

10. The method of claim 6, wherein the computation of the loss function on the server machine is performed using a cross-attention layer that calculates similarity between the embedding vector from the client and the proprietary data embeddings from the external memory.
